(19) United States
(12) Patent Application Publication
(10) Pub. No.: US 2013/0103609 A1
(43) Pub. Date: Apr. 25, 2013

(54) ESTIMATING A USER'S INTEREST IN AN ITEM

(71) Applicants: EVAN R. KIRSHENBAUM, Mountain View, CA (US); George H. Forman, Port Orchard, WA (US)

(72) Inventors: EVAN R. KIRSHENBAUM, Mountain View, CA (US); George H. Forman, Port Orchard, WA (US)

(21) Appl. No.: 13/277,322

(22) Filed: Oct. 20, 2011

(51) Int. Cl. G06Q 30/02

(52) U.S. Cl. 705/347

(57) ABSTRACT

For users in a set of users, corresponding measures of inferred interest in an item are determined. For a particular user, a particular measure of inferred interest in the item is determined. The particular measure of inferred interest and the measures of inferred interest corresponding to the users in the set of users are used to determine an estimate of the particular user's interest in the item.

### BACKGROUND

An enterprise (e.g. a corporation, educational organization, government agency, individual, etc.) may be interested in identifying candidate items that may be of interest to users, such as customers of the enterprise. The candidate items can be offerings from the enterprise, where the offerings can include goods or services from an enterprise, or other items, such as articles, persons, and so forth.

### BRIEF DESCRIPTION OF THE DRAWINGS

Some embodiments are described with respect to the following figures:

FIGS. 1A and 1B are flow diagrams of processes according to some implementations;

FIG. 2 is a block diagram of an example system according to some implementations.

### DETAILED DESCRIPTION

Users (such as customers or other users of an enterprise) may face having to select from alternative candidate items. The term “item” can refer to any offering provided by an enterprise, where the offering can include a good or service. Alternatively, an “item” can refer to any other type of item, such as an article or web page to be read, an identification of a person, and so forth.

In some cases, the set of alternative candidate items offered by an enterprise can be so large that there is risk that a user may not be able to find an item that the user is interested in and may decide to cease being a customer, or the user may miss out on something that the user would have been interested in (in which case the user may not make a purchase that the user otherwise would have made), or the user can find the number of candidate items so overwhelming that the user decides to give up selecting from among the alternative candidate items.

To reduce the burden on a user, an enterprise may recommend some subset of candidate items to the user. The hope is that the user may select one or multiple ones of the presented subset of candidate items, such as for purchase, download, review, or other action. Presenting candidate items that are potentially of interest to users may lead to increased revenue due to increased purchase of offerings, increased revenue due to increased advertisement revenue with increased traffic to a website, increased customer satisfaction, and so forth.

As examples, a storefront website (which offers goods or services at a website for purchase by users) may want to guide users to the products or services that the storefront website believes the users may wish to buy, to increase the likelihood of making a sale. Such guiding may take the form of directly suggesting products or services, or configuring web pages to highlight those sections or departments that are likely to be of interest to a user.

As another example, a news or magazine website may wish to guide users to articles and other content that the users are likely to enjoy reading, to increase the likelihood that the users will be satisfied customers and will return to the website. Increasing the number of visitors to the news or magazine website can lead to greater advertisement revenue and greater likelihood of collateral purchases.

In a further example, a movie or music streaming rental or sales service may want to focus their customers on content that the customers may find interesting to increase the likelihood of rentals or sales. A television content provider may wish to provide program guides that help their customers quickly find programs that the customers may be interested in watching and recording. A personalized print or online magazine may want to be able to select content to include in a particular subscriber's magazine that may be interesting to the subscriber. A direct mail catalog supplier may want to be able to choose products likely to appeal to a particular customer. A website may wish to be able to choose advertisements that the particular user may find most interesting and least annoying so as not to drive users away. An enterprise that wants to bundle products or services may wish to choose the products or services to include in a bundle (or bundles) that are most likely to appeal to a given user.

There can be numerous other examples where an enterprise (e.g. a corporation, educational organization, government agency, individual, etc.) may be interested in identifying candidate items (from among a larger collection of candidate items) that may be of interest to a user.

Scoring techniques can be used to produce measures of inferred interest in a given item that is offered by an enterprise. A measure of inferred interest produced by a scoring technique regarding a user's interest in an item is based on the scoring technique's determination of a level of the user's interested in the item. However, the determination of user interest made by the scoring technique may not be true, and thus the output of the scoring technique is referred to as a measure of “inferred” interest rather than a measure of actual interest.

According to some examples, a model-based scoring technique involves building a model of a user based on a history of activities of the user (such as web pages visited, products or services purchased, etc.), and using the model to produce a score (which is an example of a measure of inferred interest) for candidate items that may be recommended to the user. The candidate items with higher scores are considered by the scoring technique to be of more interest to the user. In alternative examples, candidate items with lower scores are considered by the scoring technique to be of more interest in the user.

For building a model of a given user, the given user's history may simply include information relating to whether or not the given user has visited or did not visit a web page, or whether or not the given user purchased or did not purchase an offering. In addition, the history can also include strength-of-interest values associated with a candidate item, where a strength-of-interest value may be numeric or selected from a list of alternatives and may be explicitly provided by the given user, such as when the given user assigns a particular star rating (1 star, 2 stars, 3 stars, etc.), or when the given user assigns a “thumbs up” or “thumbs down” rating. Alternatively, a strength-of-interest value may be inferred based on behavior such as whether the user made a purchase, viewed the second page of an article, or spent some amount of time (greater than a threshold) on a particular web page.

With model-based scoring techniques, in some examples, a user's history may include observations of behavior that do not have anything to do with the items that are being recommended. For example, if the task is to recommend a television show, the user's history may include web pages the user has viewed, items the user has purchased, or songs the user has listened to. The model can also take into account demographic information or information acquired by survey.

Model-based scoring techniques can include content-based scoring techniques or collaborative filtering scoring techniques. A content-based scoring technique looks at the content of a candidate item (e.g. words and phrases contained in or associated with the candidate item, keywords contained in or associated with the candidate item, concepts associated with the candidate item, etc.) and compares this content to the content that the user has previously viewed (as provided by the model) to determine the measure of inferred interest. Examples of content-based scoring techniques include Naïve Bayes and TF-IDF (Term Frequency-Inverse Document Frequency) techniques.

A collaborative filtering scoring technique pays attention to (1) the sets of users who have viewed items (user-user collaborative filtering), or (2) the sets of items that users have viewed (item-item collaborative filtering). With item-item collaborative filtering techniques, candidate items are considered interesting to a given user to the extent that the user sets corresponding to the candidate items (a “user set” includes one or multiple users interested in a respective candidate item) are similar to the user sets of items that the given user has viewed in the past. With user-user collaborative filtering techniques, candidate items are considered interesting to a given user to the extent that the candidate items are commonly viewed by users who viewed item sets are similar to the given user's viewed item set (an “item set” refers to a set of one or multiple items).

Other less sophisticated scoring techniques can include popularity-based techniques, in which a measure of inferred interest of an item can be based on a popularity of the item among multiple users. For example, an item can be classified as most viewed, most rented, most linked-to, most e-mailed, and so forth.

Another approach is to consider the user's current context (such as the web page that the user is looking at now) and produce scores for candidate items that have been popular among other users who similarly found themselves in the same context.

Another type of popularity-based scoring technique involves identifying a market segment of a given user, which can be based on the given user's history and/or demographic information such as age, sex, zip code, or income level. Popularity-based measures of inferred interest can be based on popularity within a market segment.

In some cases, different scoring techniques can be combined. For example, a model-based scoring technique can be mixed with a popularity-based scoring technique. Such a mixture may be made by performing a weighted average (or other combination) of the scores produced by multiple scoring techniques, by taking the maximum or minimum of the scores produced by multiple scoring techniques, by selecting one of multiple scoring techniques to use for a given item, or by other means.

Although a scoring technique can produce a measure of inferred interest in a given item (for a particular user), the measure of inferred interest may not reflect actual interest of the given user in the item. In other words, the scoring technique can produce a measure of inferred interest that indicates that the user has a positive interest in the item, when in fact the user is not interested in the item. On the other hand, a scoring technique may produce a measure of inferred interest that indicates that the user has a negative interest in the item (is not interested in the item) even though the user may have a positive interest in the item.

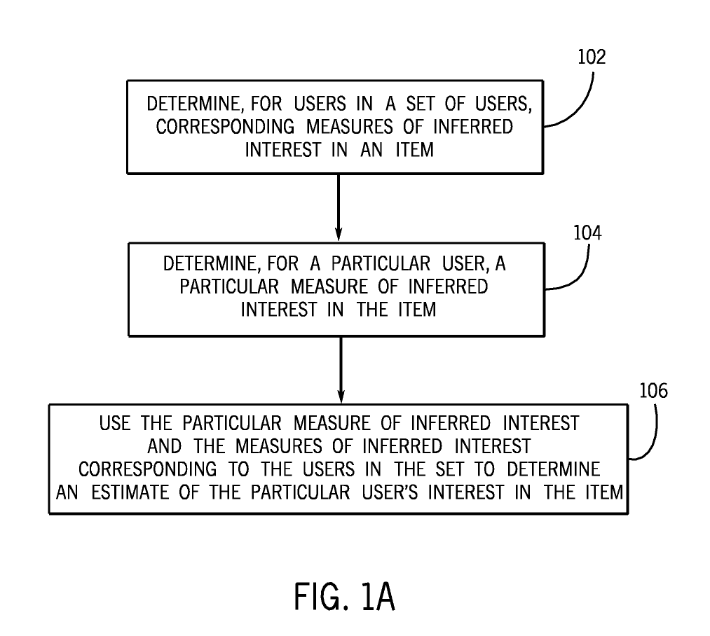

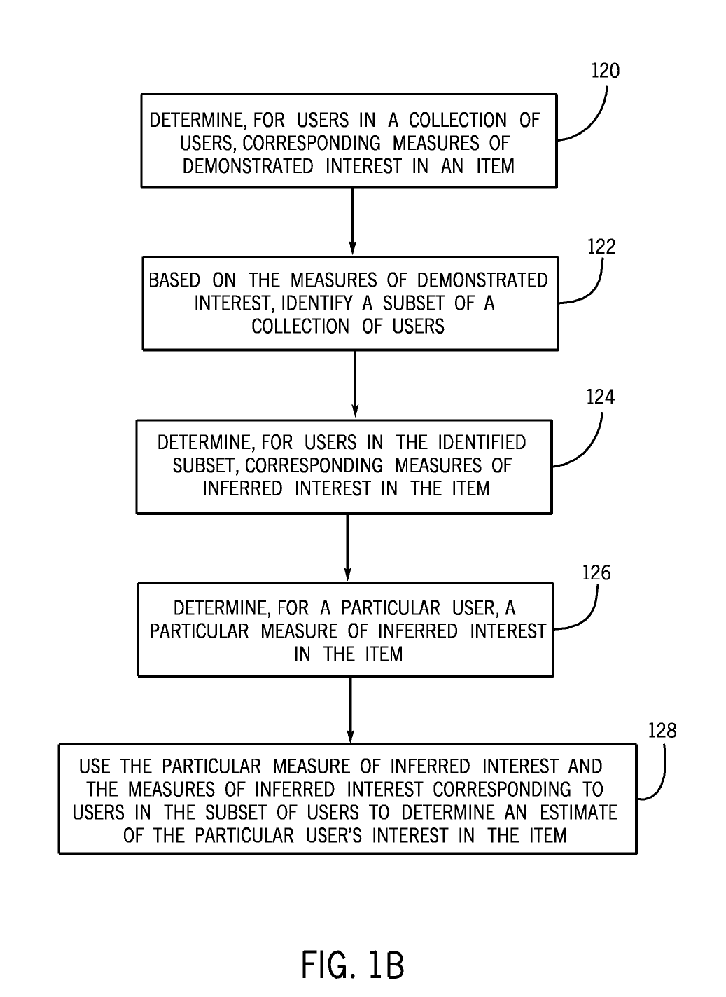

In accordance with some implementations, techniques or mechanisms are provided to improve upon results produced by a scoring technique (or a combination of scoring techniques). FIG. 1 is a flow diagram of a process according to some implementations. The process determines (at 102) for users in a set of users, corresponding measures of inferred interest in an item. The measures of inferred interests are computed by a scoring technique or combination of scoring techniques, such as any of the scoring techniques noted above.

The process also determines (at 104), for a particular user, a particular measure of inferred interest in the item. The particular measure of inferred interest is also computed by a scoring technique or combination of scoring techniques, which may be the same as or different from the scoring technique or combination of scoring techniques used at 102. The process then uses (at 106) the particular measure of inferred interest and the measures of inferred interest corresponding to the users in the set to determine an estimate of the particular user's interest in the item. The determined estimate of the particular user's interest in the item can represent a likelihood (in the form of a probability for example) of the particular user's interest in the item. Note that the determined estimate is a value that is based on scores (measures of inferred interest) produced by the scoring technique(s). Generally, the determined estimate of the particular user's interest in the item is designed to enhance the power of the scoring technique or combination of scoring techniques used to indicate measures of inferred interest in an item.

FIG. 1B is a flow diagram of a process according to further implementations. The process of FIG. 1B includes tasks in addition to those tasks depicted in FIG. 1A. The process of FIG. 1B determines (at 120), for users in a collection of users, corresponding measures of demonstrated interest in an item. A measure of demonstrated interest can be determined based on whether a user has performed an act that has demonstrated a positive interest or negative interest for the item. For example, the user may have provided an explicit feedback regarding the item (e.g., “4 stars”, “thumbs up,” “thumbs down,” etc.), from which the measure of demonstrated interest can be determined. If the user assigned “4 stars” or “thumbs up” to the item, the measure of demonstrated interest can be a positive measure to indicate that the user is interested in the item. On the other hand, if the user assigned “1 star” or “thumbs down” to the item, the measure of demonstrated interest can be a negative measure to indicate that the user is not interested in the item.

A measure of demonstrated interest can alternatively be based on other actions of a user. For example, the user, after viewing information pertaining to an item, may have purchased a different item, which indicates a negative interest in the first item. Other acts that demonstrate interest in an item can include viewing the item (such as at a website) for longer than some predefined period of time, or retrieving additional information pertaining to the item. There can be other examples of acts by a user that demonstrate either positive or negative interest in the item. Note also that a measure of demonstrated interest can be more than just positive interest and negative interest—there can be multiple levels of interest, such as positive, neutral, negative, or different levels of interest (e.g., “1 star,” “2 stars,” “3 stars,” “4 stars,” “5 stars”).

Based on the measures of demonstrated interest, a subset of a collection of users is identified (at 122). The identified subset of users can be the subset of users who have demonstrated positive interest in the item. Alternatively, the identified subset of users can include users who have demonstrated negative interest in the item. As yet a further alternative, both the positive and negative subsets of users can be identified. As a yet another alternative, there may be multiple subsets corresponding to multiple strength-of-interest values. In further alternatives, the subsets may be restricted to containing only users with some property, such as being determined to be in a particular market segment, having certain demographic or historical information in common, or otherwise being considered to be members of a particular class of users, where the particular user (for which a particular measure is determined at 126) is a member of the same class.

The process determines (at 124), for users in the identified subset, corresponding measures of inferred interest in the item. As noted above, the measures of inferred interest are measures output by a scoring technique or a combination of scoring techniques. In addition, the process determines (at 126), for a particular user, a particular measure of inferred interest in the item.

The process then uses (at 128) the particular measure of inferred interest and the measures of inferred interest corresponding to users in the subset of users to determine an estimate of the particular user's interest in the item.

In implementations where both the positive subset and negative subset of users are identified, then the determining at 124 is performed for both the positive and negative subsets of users, and task 128 uses the measures of inferred interest corresponding to users in both the positive and negative subsets to determine an estimate of the particular user's interest in the item.

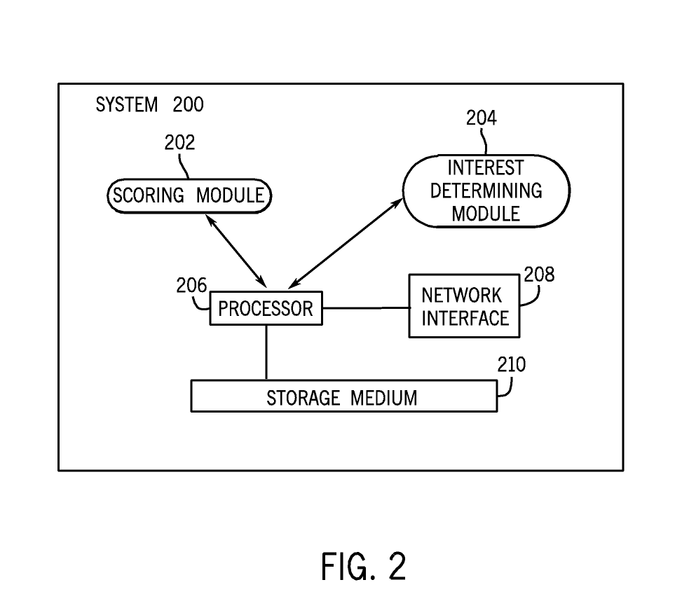

FIG. 2 is a block diagram of an example system 200 according to some implementations. The system 200 includes a scoring module 202, which can apply a scoring technique or a combination of scoring techniques, such as those noted above. The measures of inferred interest mentioned in connection with FIGS. 1A and 1B are provided by the scoring module 202.

The system 200 also includes an interest determining module 204, which can perform the tasks of FIG. 1A or 1B. The scoring module 202 and interest determination module 204 are executable on a processor (or multiple processors) 206. The system 200 also includes a network interface 208 to allow the system 200 to communicate over a network.

In addition, the system 200 includes a storage medium (or storage media) 210, which can store various information, including sets of users, sets of candidate items, scores for candidate items, results of the interest determination module 204, and so forth.

The following sets forth further details regarding some implementations. Although various details are provided below, note that different details can be used in other examples.

Let C be a set of candidate items, U a set of users, M a scoring technique, and M(u, c) a score associated by the scoring technique for user u∈U to candidate item c∈C. The score provided by the scoring technique is an example of a measure of inferred interest discussed above in connection with FIG. 1A or 1B. A parameter l(u, c) is true if user u finds candidate c interesting. The goal is to find argmax_{c∈C} P[l(u, c)]—in other words, the candidate item(s) in C that has or have the highest probability of being interesting to a given user. Generally, the function P[A] is the probability that condition A is true and P[A|B] is the probability that condition A is true conditional on condition B being true.

For each candidate item c, two statistical distributions D_{c}⁺ and D_{c}⁻ can be tracked. D_{c}⁺ is the distribution (more generally “collection”) of scores (provided by the scoring technique M) for a first subset of users U_{c}⁺ determined to have found c interesting (such as inferred by their having visited c and/or having rated c positively). Similarly, D_{c}⁻ is the distribution (more generally “collection”) of scores from a second subset of users U_{c}⁻ determined to not have found c interesting. The second subset of users U_{c}⁻ includes some or all of the users who either rated c unfavorably or who did not view c but were judged to have had the opportunity (e.g. the users viewed some page during the time window when c was considered relevant or they viewed some page that had a link to c). Users in U_{c}⁺ are considered to have a demonstrated positive interest (these are users whose measures of demonstrated interest indicate a positive interest in c), and users in U_{c}⁻ are considered to have demonstrated negative interest (these are users whose measures of demonstrated interest indicate a negative interest in c).

In further examples, the statistical distributions D_{c}⁺ and D_{c}⁻ can be restricted to market segments. For example, the first subset of users U_{c}⁺ can be made up of users for a particular market segment, and similarly, the second subset of users U_{c}⁻ can be made up of users for a particular market segment.

In the context of the process of FIG. 1B, the first subset or second subset noted above can be the subset identified at 124. As noted above, techniques or mechanisms seek to increase the power of the measure M(u, c) produced by the scoring technique M, by determining an estimate of the particular user's interest in the item (performed at 106 in FIG. 1A or 128 in FIG. 1B). In some implementations, this estimate is a probability that the particular user u who has the score M(u, c) provided by the scoring technique M is interested in the candidate item c. Such probability is represented as P[l(u, c)|M(u, c)], which represents the probability that a user u is interested in candidate item c (in other words, the probability that I(u, c) is true, given a score M(u, c) produced by the scoring technique M).

The following describes how P[I(u, c)|M(u, c)] is computed, according to some examples.

For each of the statistical distributions D_{c}⁺ and D_{c}⁻ noted above, a corresponding parametric probability distribution is modeled. In some implementations, each distribution D_{c}⁺ or D_{c}⁻ is modeled as a normal distribution having a mean and a standard deviation. To compute the mean and standard deviation, the number of scores, the sum of the scores, and the sum of the squares of the scores can be tracked. Given probability distributions corresponding to D_{c}⁺ or D_{c}⁻, the following can be defined:

D_{c}⁺(M(u, c))=P[M(u, c)|(u, c)], (Eq. 1)

D_{c}⁻(M(u, c))=P[M(u, c)|Ī( u̅,̅ c̅)̅]. (Eq. 2)

D_{c}⁺(M(u, c)) represents the probability of a user's score M(u, c) in D_{c}⁺, which is the probability that a user (u) that is interested in c will have that score. D_{c}⁻(M(u, c)) represents the probability of a user's score M(u, c) in D_{c}⁻, which is the probability that a user (u) that is not interested in c will have that score.

According to Bayes rules,

P[A|B]P[B]=P[AB]=P[B|A]P[A], (Eq. 3)

so

$$P [ A \vert B ] = \frac{P [ B \vert A ] P [ A ]}{P [ B ]} . \qquad ( Eq . 4 )$$

As noted above, an example of the determined estimate (determined at 106 in FIG. 1A or 128 in FIG. 1B) is P[I(u, c)|M(u, c)], which can be defined as:

$$\begin{matrix}P [ I ( u , c ) \vert M ( u , c ) ] = \frac{P [ M ( u , c ) \vert I ( u , c ) ] P [ I ( u , c ) ]}{P [ M ( u , c ) ]} \\ = \frac{{D}_{c}^{+} ( M ( u , c ) ) P [ I ( u , c ) ]}{P [ M ( u , c ) ]} .\end{matrix} \qquad ( Fig . 5 )$$

Further,

$$\begin{matrix}\begin{matrix}P [ \overline{I ( u , c} ) \vert M ( u , c ) ] = \frac{P [ M ( u , c ) \vert \overline{I ( u , c} ] P [ \overline{I ( u , c )} ]}{P [ M ( u , c ) ]} \\ = \frac{\\ {D}_{c}^{-} ( M ( u , c ) ) P [ \overline{I ( u , c )} ]}{P [ M ( u , c ) ]} ,\end{matrix} \\ so & ( Eq . 6 ) \\ \begin{matrix}R = \frac{P [ I ( u , c ) \vert M ( u , c ) ]}{P [ \overline{I ( u , c )} \vert M ( u , c ) ]} \\ = \frac{{D}_{c}^{+} ( M ( u , c ) ) P [ I ( u , c ) ]}{{D}_{c}^{-} ( M ( u , c ) ) P [ \overline{I ( u , c )} ]} ,\end{matrix} & ( Eq . 7 )\end{matrix}$$

where R represents the likelihood ratio that user u is interested in candidate item c.

As provided in Eq. 7, the likelihood ratio R depends on P[I(u, c)] and P[ I̅(̅u̅,̅ c̅)̅], which are unknown. However, the numbers of scores in D_{c}⁺ and D_{c}⁻ can provide an approximation of P[I(u,c)] and P[I(u,c)]. If n(D_{c}⁺) is the number of samples in D_{c}⁺, and n(D_{c}⁻) is the number of samples in D_{c}⁻, then an estimate of P[I(u, c)] is computed as follows:

$$P [ \hat{I ( u , c )} ] = \frac{n ( {D}_{c}^{+} )}{n ( {D}_{c}^{+} ) + n ( {D}_{c}^{-} )} . \qquad ( Eq . 8 )$$

Substituting Eq. 8 into Eq. 7 for R, the following is obtained:

$$\begin{matrix}R = \frac{{D}_{c}^{+} ( M ( u , c ) ) P [ \hat{I ( u , c )} ]}{{D}_{c}^{-} ( M ( u , c ) ) P [ {I ( u , c )}^{\hat{\_}} ]} \\ = \frac{{D}_{c}^{+} ( M ( u , c ) ) \frac{n ( {D}_{c}^{+} )}{n ( {D}_{c}^{+} ) + n ( {D}_{c}^{-} )}}{{D}_{c}^{-} ( M ( u , c ) ) \frac{n ( {D}_{c}^{-} )}{n ( {D}_{c}^{+} ) + n ( {D}_{c}^{-} )}} \\ = \frac{{D}_{c}^{+} ( M ( u , c ) ) n ( {D}_{c}^{+} )}{{D}_{c}^{-} ( M ( u , c ) ) n ( {D}_{c}^{-} )} .\end{matrix} \qquad ( Eq . 9 )$$

Another way to look at Eq. 9 is that the numerator represents the expected number of users in U_{c}⁺ that have the same score M(u, c) as u and the denominator is, similarly, the expected number of users in U_{c}⁻ that have the same score M(u, c) as u. Defining

mass_{u,c}⁺=D_{c}⁺(M(u, c))n(D_{c}⁺), (Eq. 10)

mass_{u,c}⁻=D_{c}⁻(M(u, c))n(D_{c}⁻), (Eq. 11)

then

$$R = \frac{{mass}_{u , c}^{+}}{{mass}_{u , c}^{-}} . \qquad ( Eq . 12 )$$

### Since

P[ l̅(̅u̅,̅ c̅)̅|M(u, c)]=(1−P(I(u, c)|M(u, c)]) (Eq. 13)

if

$$\begin{matrix}\begin{matrix}R = \frac{P [ I ( u , c ) \vert M ( u , c ) ]}{P [ \overline{I ( u , c )} \vert M ( u , c ) ]} \\ = \frac{P [ I ( u , c ) \vert M ( u , c ) ]}{( 1 - P [ I ( u , c ) \vert M ( u , c ) ] ) ,}\end{matrix} \\ then & ( Eq . 14 ) \\ \begin{matrix}P [ I ( u , c ) \vert M ( u , c ) ] = R ( 1 - P [ I ( u , c ) \vert M ( u , c ) ] ) \\ = R - RP [ I ( u , c ) \vert M ( u , c ) ] ,\end{matrix} & ( Eq . 15 ) \\ P [ I ( u , c ) \vert M ( u , c ) ] ( 1 + R ) = R , & ( Eq . 16 ) \\ \begin{matrix}P [ I ( u , c ) \vert M ( u , c ) ] = \frac{R}{R + 1} \\ = \frac{\frac{{mass}_{u , c}^{+}}{{mass}_{u , c}^{-}}}{\frac{{mass}_{u , c}^{+}}{{mass}_{u , c}^{-}} + 1} \\ = \frac{\frac{{mass}_{u , c}^{+}}{{mass}_{u , c}^{-}}}{\frac{{mass}_{u , c}^{+} + {mass}_{u , c}^{-}}{{mass}_{u , c}^{-}}} \\ = \frac{{mass}_{u , c}^{+}}{{mass}_{u , c}^{+} + {mass}_{u , c}^{-}} .\end{matrix} & ( Eq . 17 )\end{matrix}$$

which is an example of the estimate produced at 106 in FIG. 1A or 128 in FIG. 1B: the probability that a user (u) will be interested in the candidate item (c) given that the user has a certain score M(u, c) for that candidate item. So given a particular score M(u, c) from the scoring technique, the positive mass mass_{u,c}⁺ and negative mass mass_{u,c}⁻ are computed based on the probability distributions D_{c}⁺(M(u, c)) and D_{c}⁻(M(u, c)) and from the positive mass and negative mass the probability P[l(u, c)|M(u, c)] is derived.

Eqs. 1 and 2 above specify that D_{c}⁺(M(u, c))=P[M(u, c)|I(u, c)], and D_{c}⁻(M(u, c))=P[M(u, c)| I̅(̅u̅,̅ c̅)̅]. The probabilities P[M(u, c)|I(u, c)] and P[M(u,c)| I̅(̅u̅,̅ c̅)̅] in some implementations are probability density functions (PDFs). A PDF of the score M(u, c) is the fraction of scores expected to have that particular value (the value of M(u, c)). If the distribution D_{c}⁺ or D_{c}⁻ is modeled as a normal distribution having mean μ and variance σ², then the fraction (represented as D(x) below) of the score (x below) can be computed as

$$D ( x ) = \frac{{e}^{- \frac{{( x - μ )}^{2}}{2 {σ}^{2}}}}{\sqrt{2 {πσ}^{2}}} .$$

In the above equation, x is equal M(u, c). In alternative implementations, approximations to this computation may be used.

In other implementations, instead of using a PDF of a score to represent the probability, a cumulative density function (CDF) of the score can be used. The CDF of a score is the fraction of scores expected to have a value at least as high as that particular value. The CDF can be computed as follows: compute the fraction of scores that are up to this value, and this faction can be subtracted from 1 to obtain the CDF of the score. If the distribution D_{c}⁺ or D_{c}⁻ is modeled as a normal distribution or other continuous distribution, the CDF may be computed as the integral of the PDF from the particular value to positive infinity. In alternative embodiments, approximations to these computations may be used.

More generally, the probability can be any one of the following: an estimate of a likelihood that a value equal to the score occurs given the probability distribution D_{c}⁺ or D_{c}⁻, an estimate of a likelihood that a value at least as large as (or, alternatively, no larger than) the particular measure of inferred interest occurs given the probability distribution D_{c}⁺ or D_{c}⁻, an estimate of a likelihood that a value at least as far from and on the same side of the mean (or other central tendency) as the particular measure of interest occurs given the probability distribution D_{c}⁺ or D_{c}⁻, and an estimate of a likelihood that a value within a range around the particular measure of inferred interest occurs given the probability distribution D_{c}⁺ or D_{c}⁻. A range around a particular score can be defined as containing scores within a constant value of the particular score, containing scores whose percentile in the distribution is within a constant value of the percentile in the distribution of the particular score, containing scores within a certain number of the distribution's standard deviations of the particular score, and so forth. A range can be symmetric or asymmetric.

The foregoing discussion referred to use of one scoring technique M. In alternative implementations, multiple scoring techniques can be used. To do so, D_{c}⁺ and D_{c}⁻ are computed as joint distributions. For example, if scoring techniques M₁ and M₂ are used, then each of D_{c}⁺ and D_{c}⁻ is a function over the pair (M₁, M₂).

There are some special cases that are considered in some implementations. A first special case involves when all of the scores for a given candidate item in one or both of the distributions D_{c}⁺ and D_{c}⁻ have the same value. Such case may not be uncommon if the underlying scoring technique decides that there is not sufficient data on the candidate item to work from, in which case the scoring technique may assign the same score value to each user (e.g. score of 0 or 0.5). This special case also involves when either distribution D_{c}⁺ or D_{c}⁻ has fewer than two distinct score values. In the first special case, the variance for the distribution D_{c}⁺ or D_{c}⁻ is zero, and an error may occur when computing the PDF or CDF. In cases in which the variance is zero, a system (e.g. system 200 in FIG. 2) according to some implementations may determine that the system is unable to use the scores computed by the underlying technique to estimate a user's interest in a candidate item. As a result, the system may elect to not recommend the candidate item, or the system may use some other indication related to the candidate item to estimate a user's interest. An example of such other indication includes an overall probability as the best estimate, where the overall probability is computed as

$$P [ I ( u , c ) ] = \frac{n ( {D}_{c}^{+} )}{n ( {D}_{c}^{+} ) + n ( {D}_{c}^{-} )} .$$

The overall probability as calculated above basically represents the popularity of the given candidate item among all users. Note that different candidate items may have different overall probability values, such that the different candidate items can be ranked based on the respective probability values.

In a second special case, if the scores for all candidate items for a given user have the same value, the system may take this as an indication that the system has not learned anything useful about the given user, and so the system can elect to not recommend any candidate item, or can use the overall probability as noted above.

In some examples, a threshold th can be defined such that the system uses the overall probability (noted above) for any candidate that has fewer than th positive or negative cases.

The system 200 of FIG. 2 can also maintain the distributions D_{c}⁺ and D_{c}⁻ for each candidate item. The system 200 is able to handle notifications that a user has viewed, interacted with, or otherwise indicated that the user should be considered to be in the positive distribution U_{c}⁺ for some candidate item. When a user is added to the positive distribution U_{c}⁺ the user's model can be updated. In some cases, updating a user's model may cause models for other users to be updated. Later, for any user whose model has been updated, new scores are computed for all candidate items (both those for which the user is negative and those for which the user is positive). It can be assumed that sufficient data is maintained such that the system 200 knows what scores the user has previously added to which candidate item's distributions, whether those scores were considered positive or negative, and whether a user is now positive, negative, or neither for any candidate item.

When updating the score for a given candidate item, there are a number of cases to consider:
The user had previously been positive for the candidate item (i.e. the user had previously been included in U_{c}⁺) and is still positive. The new score replaces the old score in D_{c}⁺, but n(D_{c}⁺) is unchanged.
The user had previously been negative for the candidate item (i.e. the user had previously been included in U_{c}⁻) but it is now positive. The new score is added to D_{c}⁺, and the old score is removed from D_{c}⁻. In this case n(D_{c}⁺) is decremented, while n(D_{c}⁻) is incremented.
The user previously had no score for the candidate item but is now positive. The new score is added to D_{c}⁺, and n(D_{c}⁺) is incremented.
The user previously had no score for the candidate but now, due to another visit, is considered negative. The new score is added to D_{c}⁻, and n(D_{c}⁻) is incremented.
The user had previously been negative for the candidate item and is still negative. The new score replaces the old score in D_{c}⁻, but n(D_{c}⁻) is unchanged.
The user had previously been positive for the candidate item but is now negative. This can happen when the user gives a negative rating to a candidate item that had been inferred or rated positive. The new score is added to D_{c}⁻, and the old score is removed from D_{c}⁺. In this case, n(D_{c}⁻) is incremented, and n(D_{c}⁺) is decremented.
The user previously had no score, and the system still has no reason to indicate the user as positive or negative. No score is computed.

The various techniques or mechanisms described above take an underlying scoring technique (or set of scoring techniques) and determine, for each candidate item, an estimate (“interestingness estimate”) of a user's interest in the candidate item. Such interestingness estimates for respective candidate items can then be used to create an ordered list of the m (where m≧1) best candidates.

An approach according to some implementations is to take the candidate items with the m highest interestingness estimates, sorted by estimate values. It may, however, be beneficial to use the interestingness estimates as a way to focus the system on a set of “very interesting” candidates and then use some other criterion (possibly along with the estimates) to determine the final set and ordering. For example, recency of publication of an article may be an indication of interestingness—more recent articles may be considered more interesting than less recent articles. To recommend the top m articles for a user, the foregoing techniques can be implemented to select the top l articles (according to the l highest estimates), where l>m, and then from these l articles the m most recent articles are selected—the m articles can be sorted either by recency or by the interestingness estimates. Alternatively, instead of specifying a focus set that includes the top l articles according to the interestingness estimates, the focus set can include those articles with interestingness estimates greater than an interestingness estimate threshold; the m articles are then selected from this focus set according to the criterion noted above.

In this way, if there are interesting recent articles, those will be recommended—however, if the most interesting articles are all old, the most recent of the articles are recommended. In alternative examples, rather than specify (Note that this “focus set” may be specified by a threshold interestingness level rather than a set size.)

In other domains, other criteria may be used. For instance, if the goal is to customize a web page to display five products and the focus set has identified eight that the user is likely to be very interested in, the five selected might be those five (of the eight) that yield the highest profit to an enterprise.

Instead of merely recommending some set of candidate items using techniques or mechanisms described above, different implementations can customize content using the recommended candidate items. Customizing the content can involve modifying a presentation made to a user.

For example, the customization can involve including a reference to a candidate item in a list of references to recommended candidate items. As another example, the customization can take the form of including a candidate item into a larger item, such as a customized magazine, catalog, web page presented by a storefront website, brochure, and so forth. The customization can take the form of a proposed bundle of candidate items that are offered to the user. The customization may take the form of hints given to somebody other than the user (e.g. a salesperson). The customization may take the form of a playlist of songs to play for the user or advertisements to display to the user. The content being customized may be online or physical.

In other examples, the customizing can include highlighting a candidate item, facilitating discovery of a candidate item, adjusting a price of a candidate item, and hiding a candidate item from view. Facilitating discovery of a candidate item can include any one or combination of the following, as examples: making a section the candidate item is in more prominent than other sections, returning the candidate item higher in lists of search results, or listing the candidate item near the beginning of lists of items.

Various modules described above, such as the scoring module 202 and interest determining module 204, can be loaded for execution on a processor or processor (such as 206 in FIG. 2). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method performed by a system having a processor, comprising:
determining, for users in a set of users, corresponding measures of inferred interest in an item;
determining, for a particular user, a particular measure of inferred interest in the item; and
using the particular measure of inferred interest and the measures of inferred interest corresponding to the users in the set of users to determine an estimate of the particular user's interest in the item.

2. The method of claim 1, further comprising:
determining, for users in a collection of users, corresponding measures of demonstrated interest in the item; and
identifying, based on the measures of demonstrated interest, a subset of the collection of users to form the set of users.

3. The method of claim 2, wherein identifying the subset of the collection of users comprises identifying users whose measures of demonstrated interest indicate positive interest in the item.

4. The method of claim 3, wherein the subset of the collection of users is a first subset, the method further comprising:
identifying a second subset of the collection of users based on determining a negative measure of demonstrated interest in the item for each of the users in the second subset, and
determining, for each user in the second subset of users, a measure of inferred interest in the item,
wherein determining the estimate of the particular user's interest in the item is further based on the measures of inferred interest corresponding to the users in the second subset.

5. The method of claim 2, wherein identifying the subset of the set of users comprises identifying users whose measures of demonstrated interest indicate a negative interest in the item.

6. The method of claim 2, wherein determining the measure of demonstrated interest for a given user comprises receiving from the given user an indication of a level of interest.

7. The method of claim 2, wherein determining the measure of demonstrated interest for a given user comprises determining a positive measure of interest for the given user, wherein determining the positive measure comprises determining that the given user has interacted with the item.

8. The method of claim 2, wherein determining the measure of demonstrated interest for a given user comprises determining a negative measure of interest for the given user, wherein determining the negative measure comprises determining that the user has not interacted with the item even though the item was available to or presented to the given user at a time when the given user interacted with other items.

9. The method of claim 1, further comprising including the item in a set of items chosen from a plurality of candidate items based on the estimate of the particular user's interest in the item.

10. The method of claim 9, further comprising recommending selected items in the set of items to the user based on a criterion that is different from the estimate of the particular user's interest in the item.

11. An article comprising at least one machine-readable storage medium storing instructions that upon execution cause a system to:
identify, based on measures of demonstrated interest in an item for corresponding users of a set, a subset of the set of users;
determine, for the users in the subset, corresponding measures of inferred interest in the item, wherein the measures of inferred interest are provided by at least one scoring technique;
determine, for a particular user, a particular measure of inferred interest in the item; and
determine an estimate of the particular user's interest in the item based on the particular measure of inferred interest and the measures of inferred interest corresponding to the users in the subset.

12. The article of claim 11, wherein the instructions upon execution cause the system to further:
modify, based on the estimate of the particular user's interest in the item, a presentation to the user, the modifying selected from among including the item in another structure, highlighting the item, facilitating discovery of the item, adjusting a price of the item, hiding the item, and providing a hint regarding the item.

13. The article of claim 11, wherein the instructions upon execution cause the system to further:
determine a probability distribution based on the measures of inferred interest corresponding to the subset of users,
wherein determining the estimate comprises determining based on the probability distribution a probability estimate related to the particular measure of inferred interest.

14. The article of claim 13, wherein the probability distribution is a normal distribution.

15. The article of claim 13, where the probability estimate is one selected from among:
an estimate of a likelihood that a value equal to the particular measure of inferred interest occurs given the probability distribution,
an estimate of a likelihood that a value at least as large as the particular measure of inferred interest occurs given the probability distribution, and
an estimate of a likelihood that a value within a range around the particular measure of inferred interest occurs given the probability distribution.

16. The article of claim 11, wherein the subset of the set of users and the particular user are members of a class of users.

17. The article of claim 11, wherein the instructions upon execution cause the system to further:
determining, for a second item, that measures of inferred interest computed for the second item do not allow for computation of an estimate of the particular user's interest in the second item; and
in response to determining that the measures of inferred interest computed for the second item do not allow for computation of the estimate of the particular user's interest in the second item, using a different indication associated with the second item to estimate the particular user's interest in the second item.

18. A system comprising:
at least one processor to:
determine, for users in a set of users, corresponding measures of inferred interest in an item;
determine, for a particular user, a particular measure of inferred interest in the item; and
use the particular measure of inferred interest and the measures of inferred interest corresponding to the users in the set of users to determine an estimate of the particular user's interest in the item.

19. The system of claim 18, wherein the at least one processor is to further:
determine, for users in a collection of users, corresponding measures of demonstrated interest in the item; and
identifying, based on the measures of demonstrated interest, a subset of the collection of users to form the set of users.
